(19) United States
(12) Patent Application Publication
(10) Pub. No.: US 2026/0361990 A1
(43) Pub. Date: Nov. 12, 2026

(54) Thermal-Based Frame Rate Modulation of an Image Sensor for SoC and Enclosure Thermal Control

(71) Applicant: Google LLC, Mountain View, CA (US)

(72) Inventors: Mohsen Heidarinejad, San Jose, CA (US); Chunwei Yu, Saratoga, CA (US); Arpit Mittal, San Jose, CA (US)

(73) Assignee: Google LLC, Mountain View, CA (US)

(21) Appl. No.: 19/201,311

(22) Filed: May 7, 2025

(51) Int. Cl. H04N 23/60; H04N 23/951

(52) U.S. Cl. CPC H04N 23/60; H04N 23/951

(57) ABSTRACT

This document describes systems and techniques for dynamically modulating the frame rate of an image sensor of an electronic device. In various aspects, device monitors provide operational data, including temperature data, or power supply data to respective image sensor control modules. Generally, the image sensor control modules are configured to determine a frame rate adjustment value based on the data and provide the adjustment value to an image sensor frame rate controller. In some cases, an image sensor control module can be configured to predict future device operational states, including component temperatures and power consumption, to enable frame rate adjustment determinations. Based on the adjustment values or predetermined factors, the image sensor frame rate controller can determine a frame rate setting for an image sensor device to balance thermal management of an electronic device with quality and performance.

### BACKGROUND

Many personal electronic devices come equipped with advanced display technology, reliable communication systems, and multiple digital camera assemblies. Much to the satisfaction of users of personal electronic devices, these multiple digital camera assemblies enable improved image quality, increased optical zoom levels, wide-angle photography, and other such benefits. High utilization of digital camera assemblies, however, often generates system-on-chip (SoC) processing workloads that can cause heat buildup in chip assemblies and within electronic device enclosures, which in turn can degrade SoC or camera performance.

### SUMMARY

This document describes systems and techniques for dynamic frame rate modulation for an image sensor of an electronic device. In aspects, a method of an electronic device includes receiving, by a first image sensor control module, an indication of first operational data from a first component of a mobile computing device; determining, by the first image sensor control module, a first frame rate adjustment for the image sensor based on the indication of the first operational data; providing, by the first image sensor control module, the first frame rate adjustment for the image sensor to an image sensor frame rate controller; determining, by the image sensor frame rate controller, a frame rate setting for the image sensor based on at least the first frame rate; and setting a frame rate parameter of the image sensor based on the frame rate setting determined for the image sensor by the image sensor frame rate controller.

In some aspects, a system-on-chip (SoC) for managing a frame rate of an image sensor includes an interface to an image sensor, with the image sensor configured to operate based on a frame rate setting and provide an indication of a current frame rate of the image sensor. The SoC may also include an image sensor control module operably coupled to the interface to the image sensor, with the image sensor control module configured to receive an indication of operational data from a component of a mobile computing device in which the SoC is embodied and determine a frame rate adjustment based on the indication of the operational data. An image sensor frame rate controller of the SoC is operably coupled to the image sensor control module and the image sensor and configured to receive the frame rate adjustment and the current frame rate, determine a frame rate setting for the image sensor, and set a frame rate parameter of the image sensor based on the frame rate setting determined for the image sensor by the image sensor frame rate controller.

In other aspects, computer-readable media store processor-executable instructions that, responsive to execution by a hardware-based processor, implement a frame rate control system for an image sensor of a mobile computing device. The frame rate control system receives, by an image sensor control module, an indication of operational data from a component of a mobile computing device and determines, by the image sensor control module, a frame rate adjustment for the image sensor based on the indication of the operational data. The image sensor control module can provide the frame rate adjustment for the image sensor to an image sensor frame rate controller. The image sensor frame rate controller determines a frame rate setting for the image sensor based on the frame rate adjustment and sets a frame rate parameter of the image sensor based on the frame rate setting determined for the image sensor by the image sensor frame rate controller.

This Summary is provided to introduce simplified concepts concerning dynamic frame rate modulation for an image sensor, which is further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of dynamic frame rate modulation for an image sensor are described in this document with reference to the following drawings. The same numbers are used throughout the drawings to reference like features and components:

FIG. 1 illustrates an example environment in which an electronic device utilizes an image capture device in accordance with one or more aspects;

FIG. 2 illustrates an example implementation of the electronic device of FIG. 1 that can implement dynamic frame rates for an image sensor in accordance with one or more aspects;

FIG. 3 illustrates an example configuration of an image sensor frame rate controller in accordance with one or more aspects;

FIG. 4 illustrates an example implementation of a system for dynamically determining frame rates for an image sensor in accordance with one or more aspects;

FIG. 5 illustrates an example method for dynamically modulating a frame rate of an image sensor in accordance with one or more aspects;

FIG. 6 illustrates an example method for dynamically determining a frame rate adjustment for an image sensor based on an SoC temperature in accordance with one or more aspects;

FIG. 7 illustrates an example method for dynamically determining a frame rate adjustment for an image sensor based on a prediction of future operating parameters;

FIG. 8 illustrates an example method for dynamically determining a frame rate adjustment for an image sensor based on a sustained enclosure temperature value in accordance with one or more aspects;

FIG. 9 illustrates an example method for dynamically determining a frame rate adjustment for an image sensor in accordance with some implementations; and

FIG. 10 illustrates various components of an example computing system in which aspects of dynamic modulation of a frame rate of an image sensor can be implemented.

### DETAILED DESCRIPTION

Original equipment manufacturers of various electronic devices, such as smartphones and laptops, often embed cameras in electronic devices. These cameras enable a user of an electronic device to capture a static image (e.g., a single frame) or videos (e.g., multiple frames per second (FPS)) of a scene. In some applications, one or more cameras of an electronic device may be utilized to capture frames to generate video. When used for capturing video scenes, the cameras may place an additional processing load on a processor of the device. One effect of additional processing loads on the processor of the device includes the generation of heat. For example, the high utilization of digital camera assemblies often generates processing workloads in a system-on-chip (SoC) of the device, which can cause excess heat buildup in chip assemblies and within electronic device enclosures. This excess heat can degrade performance of the SoC or the camera.

In some cases, the original equipment manufacturers implement a fixed SoC thermal control policy to address these heat issues. A fixed thermal policy, however, generally applies predefined actions irrespective of dynamic workload and thermal conditions of the SoC. These are typically suboptimal actions for camera workloads, however, due to the highly variable and context-dependent nature of camera operations and thermal behavior. Camera workloads, such as for smartphones, are influenced by several dynamic factors, including resolution, frame rate, lighting conditions, and concurrent processing tasks (e.g., image enhancement or AI-driven features). These variations often result in fluctuating power consumption and thermal patterns, which a fixed policy cannot adequately address without impacting camera performance. For example, a static policy may either throttle performance unnecessarily during low-demand scenarios or fail to react sufficiently to rapid thermal spikes during intensive tasks, leading to user dissatisfaction or thermal instability.

In other words, the use of fixed policies lacks flexibility to adapt to real-time thermal conditions and external environmental factors. Thus, a static approach to thermal management may over- or under-compensate for these factors, either degrading user experience with excessive throttling or allowing the device to overheat, triggering severe thermal management interventions like shutting down features. Additionally, these fixed policies often fail to balance the trade-offs between thermal control and user experience effectively, as they cannot dynamically prioritize frame rate stability, visual quality, or responsiveness based on current conditions. As such, preceding fixed policies for thermal management of camera workloads often result in poor user experiences, degrade camera or SoC performance, or may result in device shutdown when excess heat overloads the SoC of the device.

In contrast with preceding techniques, this disclosure describes dynamic thermal control policies, including dynamic frame rate modulation for an image sensor of an electronic device. In various aspects, the dynamic thermal control policies can adjust actions based on real-time inputs such as temperature, power consumption, and workload intensity, which can provide better user experience and device performance. Generally, these policies may fine-tune frame per second (FPS) adjustments of the image sensor, resolution scaling, or processor throttling to ensure thermal stability while maintaining an optimal user experience. As such, the described aspects may address various tradeoffs between performance and excess heat to enable a positive user experience while maintaining necessary thermal and/or power constraints to provide reliability and longevity for the components (e.g., SoC, chip assemblies) of a mobile device.

In various aspects, dynamic frame rate modulation of an image sensor can be implemented to provide a balance between predetermined operational parameters, such as video capture rates and operating temperatures of a mobile device. In some implementations, one or more frame rate adjustment modules can be employed in a device that are configured to capture and provide operational parameters, which may include SoC temperatures, power consumption, mobile device enclosure temperatures, and predicted future temperatures. Alternatively or additionally, the operating parameters may include frame rate adjustments, which may be provided to an image sensor of the device or to a decision module that is configured to make a frame rate determination and provide a frame rate setting to the image sensor.

To this end, this document describes systems and techniques for dynamically modulating frame rates of an image sensor of an electronic device. In various aspects, device monitors provide operational data, including temperature data, or power supply data to respective image sensor control modules. Generally, the image sensor control modules are configured to determine a frame rate adjustment value based on the data and provide the adjustment value to an image sensor frame rate controller. In some cases, an image sensor control module can be configured to predict future device operational states, including component temperatures and power consumption to enable frame rate adjustment determinations. Based on the adjustment values or predetermined factors, the image sensor frame rate controller can determine a frame rate setting for an image sensor device to balance thermal management of an electronic device with quality and performance.

Additional examples and implementations are described throughout this document. The document now turns to an example operating environment, after which example environments, devices, implementations, methods, and systems are described.

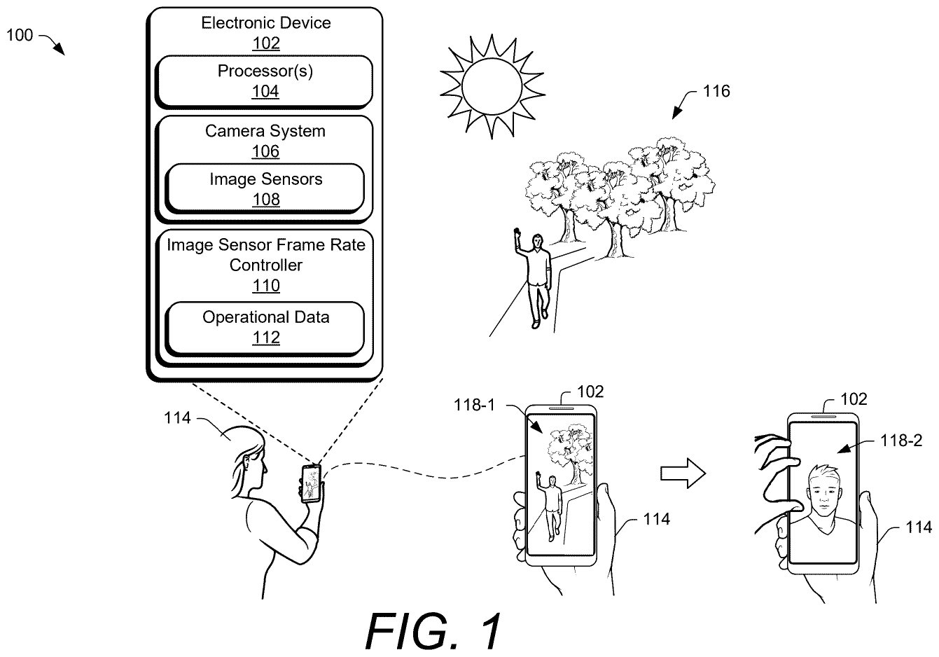

FIG. 1 illustrates an example environment 100 in which an electronic device 102 utilizes a camera system to capture and store multiple image frames in accordance with one or more aspects. The example environment 100 includes the electronic device 102, which is illustrated as a smartphone as an example only. In various aspects, the electronic device 102 can be implemented as a mobile computing device, such as a mobile phone, a tablet computer, smart-glasses, or the like. The electronic device 102 includes, or is operatively coupled to, one or more processors 104 and a camera system 106 having one or more image sensors 108. The electronic device 102 further includes an image sensor frame rate controller 110 that includes or has access to operational data 112 of the electronic device 102. As described herein, the image sensor frame rate controller 110 and the operational data 112 can be configured to implement one or more aspects of dynamic frame rate modulation for one or more image sensors 108.

In aspects, the image sensor frame rate controller 110 provides a frame rate setting for one or more of the image sensors 108 to capture image frames of a scene 116, resulting in one or more captured digital image frames (118-1 and 118-2), which may form a video of multiple image frame captures. For example, in response to a user 114 opening an image-capturing application or providing a command to the electronic device 102 to capture an image or video, the image sensor frame rate controller 110 may determine a frame rate setting for one or more image sensors 108 based on operational data 112 of the electronic device 102.

As another example, the user 114 may open an image-capturing application on the electronic device 102. In response, the camera system 106 directs one or more processors 104 to activate the one or more image sensors 108. The image sensor frame rate controller 110 can determine a frame rate based on operational data 112. The determined frame rate can then be applied by the processor 104 to the one or more image sensors 108 to set a current frame rate for the image sensors 108. Through such techniques, video and static images can be captured by the one or more image sensors 108 at a beneficial frame rate that provides a favorable user experience while balancing operational parameters such as heat buildup and processor workloads.

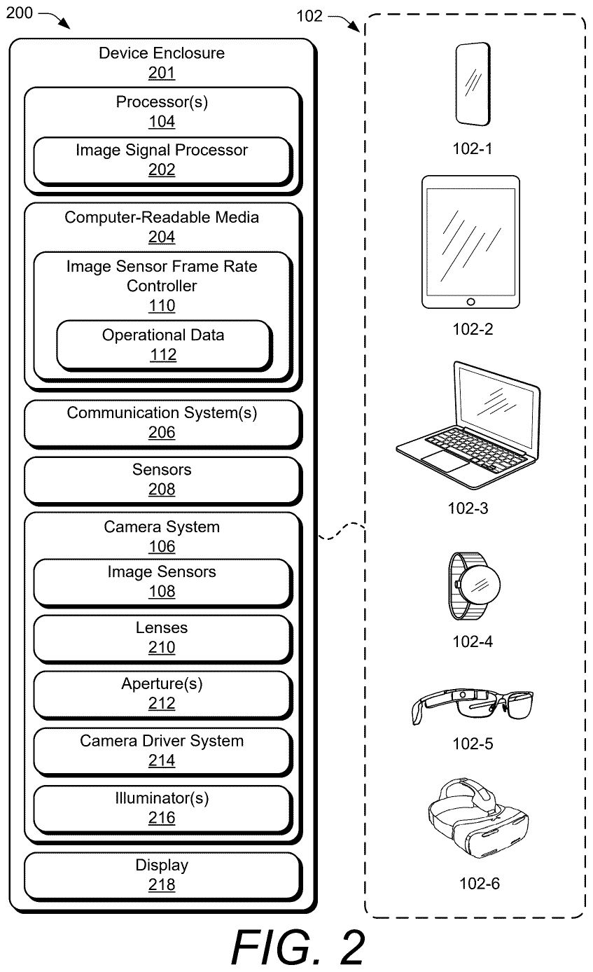

Consider FIG. 2, which illustrates an example implementation 200 of the electronic device 102 configured to implement dynamic frame rate modulation of an image sensor. The electronic device 102 of FIG. 2 is illustrated as a variety of example devices, including a smartphone 102-1, a tablet 102-2, a laptop 102-3, a computing watch 102-4, computing spectacles 102-5, and an artificial reality/virtual reality (AR/VR) headset 102-6. Although not shown, the electronic device 102 may also be implemented as any of a mobile station (e.g., fixed- or mobile-STA), a mobile communication device, a client device, a home automation and control system, an entertainment system, a gaming console, a personal media device, a health monitoring device, a drone, a camera, an Internet home appliance capable of wireless Internet access and browsing, an Internet of Things device, security systems, and the like. Note that the electronic device 102 can be wearable, non-wearable but mobile, or relatively immobile (e.g., desktops, appliances). Note also that the electronic device 102 can be used with, or embedded within, electronic devices or peripherals, such as in automobiles or as an attachment to a laptop computer. The electronic device 102 may include components or interfaces omitted from FIG. 2 for the sake of clarity or visual brevity.

In some implementations, the electronic device 102 includes a printed circuit board assembly (PCBA) on which components and interconnects of the electronic device 102 are embodied. Alternatively or additionally, components of the electronic device 102 can be embodied on other substrates, such as flexible circuit material or other insulative material, and, optionally, can be operatively coupled to the PCBA. The electronic device 102 may also include a device enclosure 201 that defines at least one internal cavity within or on which are provided thermal sensors 208 operatively coupled to the device enclosure 201 for measuring the device enclosure 201 temperature at one or more positions. In aspects, the enclosure 201 (e.g., device housing) may be supported and/or defined by a frame. The enclosure 201 includes an exterior surface and an opposing interior surface. The exterior surface may include at least one portion in contact with a physical medium (e.g., hair, skin, tissue, clothing) associated with a user or a physical medium (e.g., mount, pad) associated with auxiliary equipment. For example, the computing watch 102-4 can include an exterior surface in contact with a wrist of a user. In another example, the smartphone 102-1 can include an exterior surface in contact with a charging stand. In aspects, the enclosure 201 may be any of a variety of plastics, metals, acrylics, or glasses. In an implementation, the exterior surface of the enclosure 201 includes one or more openings, such as a port (e.g., a barometric port).

As illustrated, the electronic device 102 includes one or more processors 104 and computer-readable media 204. The processors 104 may include any suitable single-core or multi-core processor (e.g., an application processor (AP), a digital-signal processor (DSP), a central processing unit (CPU), a graphics processing unit (GPU), a computer vision and machine-learning (CVML) processor). The processors 104 may be configured to execute instructions or commands stored within the computer-readable media 204. In an example implementation, the electronic device 102 includes a multi-core system-on-chip (SoC) that is configured to parallelly execute instructions or commands stored within the computer-readable media 204. Applications and/or an operating system (not shown) implemented as computer-readable instructions on the computer-readable media 204 can be executed by the computer processors 104 to provide some or all of the functionalities described herein. In some aspects, the computer-readable media 204 may store processor-executable instructions for the image sensor frame rate controller 110, which, responsive to execution by the processors 104, can implement the image sensor frame rate controller 110 to use the operational data 112 for dynamic modulation of frame rates as described herein.

The computer-readable media 204 may be stored within one or more non-transitory storage devices such as a random access memory (RAM, dynamic RAM (DRAM), non-volatile RAM (NVRAM), or static RAM (SRAM)), a read-only memory (ROM), or a flash memory, a hard drive, a solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other but still cooperate and/or interact with each other.

At least one processor of the one or more processors 104 includes an image signal processor 202 (e.g., image processing engine, image processing unit (IPU), image processor). In an example implementation, the image signal processor 202 can be operatively coupled to, or integrated within, a multi-core SoC (e.g., an application processor). The image signal processor 202 may be a dedicated processing unit that is responsible for converting raw image data to a digital image, as well as processing and enhancing image data captured by a camera system (e.g., camera system 106). In some examples, the image signal processor 202 can perform demosaicing (e.g., to reconstruct full-color information), noise reduction, white balance, tone mapping and dynamic range compression, sharpening and detail enhancement, image stabilization, and/or compression and encoding.

The electronic device 102 may further include, or be operatively coupled to, communication systems 206. The communication systems 206 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of various IEEE 802.11 (WiFi®) standards, WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over the communication systems 206 may be packetized or framed depending on a communication protocol or standard by which the electronic device 102 is communicating. The communication systems 206 may include wired interfaces, such as Ethernet or fiber-optic interfaces for communication over a local network, a private network, an intranet, or the Internet. Alternatively or additionally, the communication systems 206 may include wireless interfaces that facilitate communication over wireless networks, such as wireless LANs, cellular networks, or WPANs.

Further illustrated, the electronic device 102 includes a plurality of sensors 208. The plurality of sensors 208 may obtain information regarding a local environment of the electronic device 102. For example, the plurality of sensors 208 can include any of a variety of sensors, such as an audio sensor (e.g., a microphone), a touch-input sensor (e.g., a touchscreen), proximity sensors (e.g., capacitive sensors, radar sensors), a depth sensor (e.g., a range estimator), an ambient light sensor (e.g., a photodetector), or temperature sensors for detecting device enclosure 201 temperatures, an SoC temperature, and/or other component temperatures of the electronic device 102. In one example, the electronic device 102 utilizes a proximity sensor of the plurality of sensors 208 to adjust a zoom level of a first image sensor to a low zoom and a zoom level of a second image sensor to a high zoom. In another example, the image sensor frame rate controller 110 is configured to provide a frame rate setting for the one or more image sensors 108 based on operational data such as an electronic device 102 enclosure temperature or an SoC processor 104 temperature.

The electronic device 102 further includes the camera system 106 having one or more image sensors 108, lens(es) 210, and apertures 212. The one or more image sensors 108, implemented as, for example, complementary metal oxide semiconductors (CMOSs), charge-coupled device (CCD) sensors, and/or any other such image-capturing technology, can be configured to capture light, such as light reflected off of one or more objects in a scene, and generate a digital signal (e.g., data relating to light of a captured scene) at different frame rates that can be dynamically adjusted while in operation by a user.

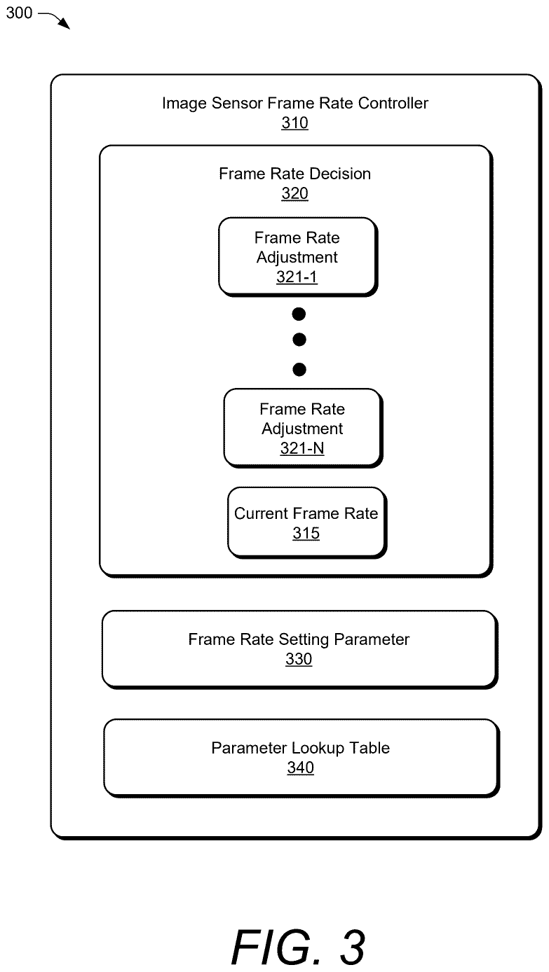

FIG. 3 illustrates at 300 an image sensor frame rate controller 310 having a frame rate decision block 320 for determining a frame rate setting parameter 330 for one or more image sensors 108 and a parameter lookup table 340. In one implementation, the image sensor frame rate controller 310 of FIG. 3 corresponds with the image sensor frame rate controller 110 as illustrated in the operating environments of FIGS. 1 and 2. The parameter lookup table 340 may hold a variety of values, including but not limited to temperature limit thresholds for an electronic device 102, such as peak SoC operating temperatures (e.g., 25, 30, 40 C, etc.), electronic device enclosure 201 temperature limits (e.g., 25, 30, 40 C, etc.), actual frame rates, (e.g., 30, 60, 90, 120 fps etc.), relative frame rate adjustment values (e.g., +10%, +20%, −10%, −20% etc.), stepwise frame rate adjustment values (e.g., −5 fps, −10 fps, +5 fps, +10 fps), a rate of change to a current frame rate 315 (e.g., relative or stepwise adjustment) over a predetermined time-period, values based on hysteresis models and linear functions or non-linear functions, and other values for access by logic to implement a frame rate decision block 320 to produce a frame rate setting parameter 330. In an aspect, the frame rate setting parameter 330 may be an explicit frame rate to apply to operate an image sensor 108 of the electronic device 102 (e.g., 30, 60, 90, 120 fps, etc.).

As illustrated in FIG. 3, the frame rate controller 310 includes the decision block 320, which is configured to receive frame rate adjustments 321-1 to 321-N and the current frame rate 315 as inputs, which the frame rate decision block 320 employs to produce the frame rate setting parameter 330. The current frame rate 315 may correspond to an operating frame rate to which an image capture device, such as the image sensor 108, is currently configured to operate in the electronic device 102. In an implementation, the frame rate decision block 320 is configured to apply predetermined metrics through logic to select one of the plurality of frame rate adjustments 321-1 to 321-N to produce a frame rate setting parameter 330 that is to balance competing operational parameters of a mobile device (i.e., electronic device 102 of FIGS. 1 and 2).

In one implementation, a frame rate setting parameter 330 is determined by the frame rate decision block 320 based on a predetermined minimum acceptable frame rate that may preserve a desired user experience. In an aspect, the parameter lookup table 340 may store values for frame rates that are acceptable for specific image capture applications that the electronic device 102 is performing such as, for example, digital video image capture, burst digital image capture, or still digital image capture, as well as frame rates acceptable at different electronic device 102 operating temperatures or other parameters such as temperature thresholds that also maintain a subjective baseline quality for user experience. For example, a minimum frame rate setting parameter can be based on factors such as determining a priority for minimizing processing overhead and heat generation, subjective image capture quality, mobile device enclosure temperature, processor temperature, or a predetermined threshold for all such operational parameters that may be determined by the image sensor frame rate controller 310 and/or stored in one or more lookup tables 340. Temperature measurements can be, for example, real-time or near real-time temperature measurements such as a peak die temperature of an SoC. In other examples, temperature values that can be used for determining a frame rate setting adjustment 321-1 to 321-N may include estimated or predicted future temperatures for components of an electronic device, such as the electronic device 102 as illustrated in FIGS. 1 and 2.

In some aspects, the image sensor frame rate controller 310 is configured to implement a gatekeeping function that is operative to determine the frame rate setting parameter 330 by comparing the frame rate adjustments 321-1 to 321-N and the current frame rate 315 to one or more stored parameters, such as predetermined frame rates, incremental frame rate changes based on temperature predictions, and/or trends that may be stored in the parameter lookup table 340. In other configurations, the frame rate adjustments 321-1 to 321-N are explicit frame rates or frame rate change values (relative or explicit) that may be determined by applying logic to device data from the electronic device 102 including power consumption, temperatures, and intended electronic device 102 use, such as high-speed digital video capture. In an aspect, the frame rate decision block 320 compares each frame rate adjustment 321-1 to 321-N to the current frame rate 315 and through logic selects among 321-1 to 321-N to determine the lowest frame rate corresponding to the set of frame rate adjustments 321-1 to 321-N for the frame rate setting parameter 330. The image sensor frame rate controller 310 can be configured in software or firmware, can be a standalone module, or can be integrated with other components of the electronic device 102 as illustrated in FIGS. 1 and 2.

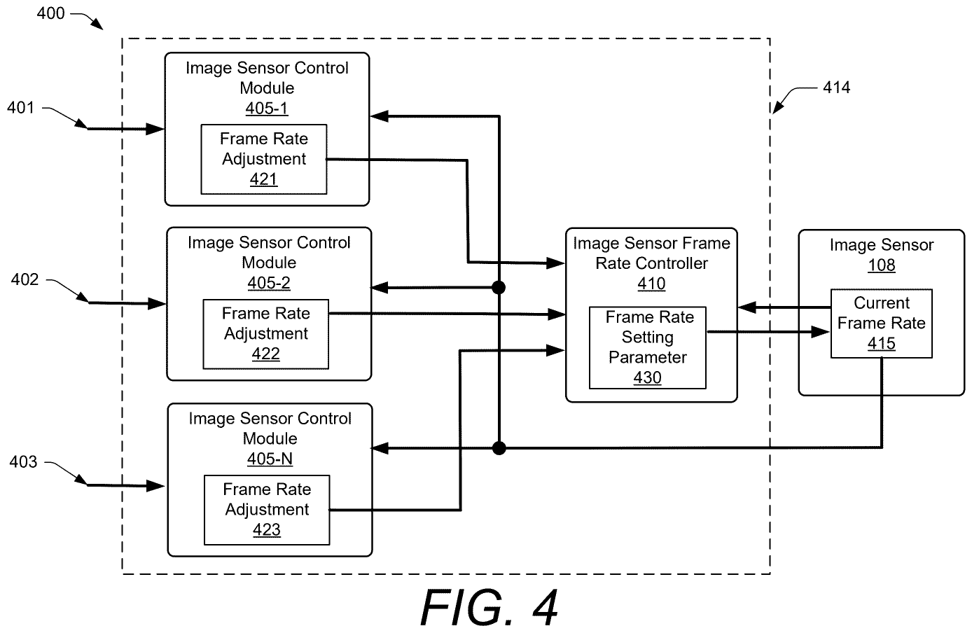

FIG. 4 illustrates an example implementation 400 of a system for dynamically controlling an image sensor frame rate. In the following discussion, reference may be made to FIGS. 1-3 and the components illustrated in each by their reference numbers. The configurations discussed forthwith are examples and non-limiting, as many other configurations with additional or fewer components are also within the scope of the current discussion.

In an example configuration, a sub-system 414 includes one or more image sensor control module(s) 405-1 to 405-N, which are configured to determine and provide frame rate adjustment(s) 421, 422, 423 to an image sensor frame rate controller 410, which is configured to provide a frame rate setting parameter 430 to control an image sensor 108. Each of the image sensor control module(s) 405-1 to 405-N may include a parameter lookup table 340 as discussed in relation to FIG. 3 that may provide predetermined values that can be used in logic to produce the frame rate adjustment(s) 421, 422, 423 to the image sensor frame rate controller 410.

As illustrated in FIG. 4, an example image sensor control module 405-1 has an input 401 and a current frame rate 415 input. In an example, and with reference to FIGS. 1 and 2, the input 401 can include operational data 112 for an electronic device 102. In one example, the input 401 comprises sensor input from sensors 208, which are configured to measure and/or monitor processor 104 temperatures. For example, a temperature measurement can be an SoC die operating temperature and a corresponding input 401 can be a peak operating die temperature of the SoC. In the current example, the image sensor control module 405-1 is configured to receive input 401 and the current frame rate 415 and then determine a frame rate adjustment 421 based on the input 401 and the current frame rate 415.

The determination of the frame rate adjustment 421 can be further based on predetermined factors such as threshold temperatures, thermal constraints, and user experience metrics for acceptable video capture quality. In a further example, an acceptable SoC operating temperature range can be divided into multiple zones that can include one or more of a safe operating zone for high frame rates, a moderate zone for reduced frame rates, and a critical zone for a minimally acceptable frame rate to attain a predetermined base level for an acceptable user experience.

In another example, an image sensor control module 405-1 is configured to employ proportional scaling to allow gradual frame rate reductions when measured temperatures approach a critical limit. In this example, a proportional scaling is calculated using a scaling factor that determines a frame rate decrement relative to a measured temperature increase, thereby avoiding any abrupt frame rate changes while still managing any potential thermal stress to various components of a mobile device 102. In yet another example, application of hysteresis bands to determine a frame rate adjustment 421 ensures that frame rate adjustments only occur when a measured temperature exceeds a predetermined threshold temperature, thereby assuring that frame rates are not changed too frequently, thus maintaining consistent visual performance. In still another example, smooth transitions between frame rates are achieved by applying time-based interpolation techniques to avoid sudden visual disruptions from rapid changes in image sensor frame rates.

In another example, an image sensor control module 405-1 is configured for a restoration mode to provide a frame rate adjustment 421-1 that incrementally restores a previous higher frame rate based on operational data 112 that indicates reduced temperatures and thermal stability for electronic device 102 components such as a processor 104. In this example, restoration logic prevents temperature oscillations and thus provides image sensor performance recovery without compromising the thermal safety of a mobile device 102.

In still another embodiment, each of the above techniques is configured to operate simultaneously such that a proportional-based adjustment provides thermal control efficiency, while hysteresis and smooth transitions through time-based interpolations mitigate abrupt and frequent frame rate changes. While fixed frame rate configurations offer simplicity, such techniques limit a more granular operation of an image sensor and thus overall performance compared to the current implementation.

In one example, an image sensor control module 405-1 determines a frame rate adjustment 421 based upon the techniques and configuration discussed above and then provides the frame rate adjustment 421 to an image sensor frame rate controller 410. In this example, the image sensor frame rate controller 410 is configured to receive the frame rate adjustment 421 along with input from an image sensor control module 405-2 and receive one or more of image sensor control modules 405-N along with a current frame rate 415 and then determine a frame rate setting parameter 430 to provide to an image sensor 108. In this manner, a dynamic frame rate adjustment can be made to operate the image sensor 108.

As illustrated in FIG. 4, an example image sensor control module 405-2 has an input 402 and a current frame rate 415 input. In an example, and with reference to FIGS. 1 and 2, the input 402 can include operational data 112 for an electronic device 102. In one example, the input 402 comprises sensor input from sensors 208, which are configured to measure and/or monitor processor 104 temperatures, electronic device 102 enclosure temperatures, and power supply data. For example, a temperature measurement can be an SoC die temperature and a corresponding input 402 can be a peak die temperature of the SoC. In another example, the input 402 can include an electronic device 102 enclosure temperature provided by the sensors 208. In yet another example, the operational data 112 can include power supply data such as power consumption, load, and temperature data, which can be provided by the sensors 208. In one current example, the image sensor control module 405-2 is configured to receive the input 402 and the current frame rate 415 and then determine a frame rate adjustment 422 based on the input 402 and the current frame rate 415.

The determination of the frame rate adjustment 422 can be based on predetermined factors such as threshold temperatures, thermal constraints, user experience metrics for acceptable video capture quality, measured temperatures, and measured power consumption and on predicted values for future temperatures and power consumption for components of the electronic device 102 as well as the current frame rate 415.

In one example, an image sensor control module 405-2 is configured to predict future electronic device 102 operational parameters based on a prediction model. In this example, operational parameters can include a future processor 104 temperature and a future enclosure temperature of the electronic device 102. In one configuration, the image sensor control module 405-2 receives an input 402 including operational data 112 from sensors 208 for current components of the electronic device 102, such as a processor 104, a display 218, an image signal processor 202, or a camera 108. In this example, the operational data 112 for components of electronic device 102 can include current power consumption and/or operating temperatures, which can then be processed with logic through a prediction model to estimate future temperature and power consumption values for various components of the electronic device 102. In one implementation, a fixed frame rate adjustment 422 can be triggered when a prediction value for an operational parameter exceeds a threshold value. For example, a threshold of 80% of total power supply capacity of the electronic device 102 can be used as a threshold to limit the ramp of frame rates to prevent future temperature increases or prevent exceeding a safe power supply consumption level. It should be understood that a threshold value for a safe percentage of power supply usage may be determined on a case-by-case basis for an electronic device 102 and is intended here not as a limiting value but merely as one example.

In another example, a prediction model may be employed to predict proximity to a thermal limit of an electronic device 102 and its components, such as a processor 104. In this example, the prediction model can estimate the likelihood of surpassing a thermal threshold within a critical time window, such as, for example, 5 to 10 seconds. A frame rate may then be determined based on the severity of a predicted overheating of a component, and a frame rate adjustment 422 can better reflect an appropriate granular frame rate change from moderate to aggressive based on predetermined safety margins. Lower frame rates can drastically reduce power consumption, which may be very desirable for some circumstances where the highest video quality is not required for the best user experience and other factors may have priority, including battery life, preventing excessive heat, and static scene capture for example.

In another configuration, a frame rate control module 405-2 determines a frame rate adjustment 421-2 based on a prediction model and application of stepwise adjustments in order to smooth a transition between subsequent frame rate changes over a time-period. In this manner, a user experience is preserved by eliminating jarring changes in frame rates in rapid succession, which may be visually disruptive.

In an example, an image sensor control module 405-2 determines a frame rate adjustment 422 based upon the techniques and configurations discussed above and then provides the frame rate adjustment 422 to an image sensor frame rate controller 410. In this example, the image sensor frame rate controller 410 is configured to receive the frame rate adjustment 422 along with input from an image sensor control module 405-1 and receive one or more of image sensor control modules 405-N along with a current frame rate 415 and then determine a frame rate setting parameter 430 to provide to an image sensor 108. In this manner, a dynamic frame rate adjustment can be made to operate the image sensor 108.

As illustrated in FIG. 4, an example image sensor control module 405-N has an input 403 and a current frame rate 415 input. In an example, and with reference to FIGS. 1 and 2, the input 403 can include operational data 112 for an electronic device 102. In one example, the input 403 comprises sensor input from sensors 208, which are configured to measure and/or monitor enclosure temperatures of the electronic device 102. For example, an enclosure temperature measurement can be a temperature measurement from a sensor 208 from one or more positions within, along, or attached to an enclosing portion of the electronic device 102. In the current example, the image sensor control module 405-N is configured to receive the input 403 and the current frame rate 415 and then determine a frame rate adjustment 423 based on the input 403 and the current frame rate 415.

The determination of the frame rate adjustment 423 can be further based on predetermined factors such as threshold temperatures, thermal constraints, and user experience metrics for acceptable video capture quality. In a further example, an electronic device 102 safe operating temperature range can be set through a defined threshold that invokes the determination of the frame rate adjustment 423. In this example, if an enclosure temperature of the electronic device 102 exceeds the defined threshold, a frame rate adjustment 423 is determined that maps the measured enclosure temperature to a frame rate using a high-resolution linear or non-linear function to allow for fine adjustment of frame rates. Such fine adjustments allow gradual reductions in frame rates as electronic device 102 enclosure temperatures rise. In the event an enclosure temperature critical limit of the electronic device 102 is reached, a frame rate control module 404-N can enforce a minimum frame rate value through a frame rate adjustment 423 until the enclosure temperature drops below the critical threshold.

In yet another example, application of hysteresis bands to determine a frame rate adjustment 423 ensures that frame rate adjustments only occur when a measured temperature exceeds a predetermined threshold temperature, thereby assuring that frame rates are not changed too frequently, thus maintaining consistent visual performance. In still another example, smooth transitions between frame rates are achieved by applying time-based interpolation techniques to avoid sudden visual disruptions from rapid changes in image sensor frame rates.

In an example, an image sensor control module 405-N determines a frame rate adjustment 423 based upon the techniques and configurations discussed herein and then provides the frame rate adjustment 423 to an image sensor frame rate controller 410. In this example, the image sensor frame rate controller 410 is configured to receive the frame rate adjustment 423 along with input from an image sensor control module 405-1 and receive inputs from image sensor control modules 405-2 along with a current frame rate 415 and then determine a frame rate setting parameter 430 to provide to an image sensor 108. In this manner, a dynamic frame rate adjustment can be made to operate the image sensor 108. Additional frame rate control modules are contemplated by the forgoing discussion, and although only three examples have been provided, this disclosure is intended to enable the addition of any additional frame rate control modules that provide frame rate adjustments to manage thermal and power consumption for an electronic device.

In the above discussion of the image sensor control modules 405-1, 405-2, and 405-N, one or more of the discussed modules may be configured for operation singularly or simultaneously depending on varying operational parameters. In one embodiment, only one of the discussed image sensor frame rate control modules 405-1, 405-2, and 405-N is configured to provide the frame rate adjustment 421, 422, and 423 to the image sensor frame rate controller 410 at a time, and the frame rate adjustment 421, 422, and 423 is assigned as the frame rate setting 430. In another example, the image sensor frame rate controller 410 is configured to receive the frame rate adjustments 421, 422, and 423 from two or more of the image sensor frame rate control modules 405-1, 405-2, and 405-N and then determine which of the provided frame rate adjustments 421, 422, or 423 may provide the best frame rate setting parameter 430 based on predetermined metrics including a hysteresis model and smoothness of frame rate transitions, ensuring minimal user experience disruption, thermal policy limits, and proximity to thermal thresholds for SoC temperature and enclosure temperature.

In an example configuration, a sub-system 414 includes one or more image sensor control module(s) 405-1 to 405-N, which are configured to determine and provide frame rate adjustment(s) 421, 422, 423 to an image sensor frame rate controller 410, which is configured to provide a frame rate setting parameter 430 to control an image sensor 108. In one example, the sub-system 414 is a combined system in software or firmware and the image sensor frame rate controller 410 functions only as a gatekeeper for the image sensor control module(s) 405-1 to 405-N if there are conflicting frame rate adjustment values 421, 422, 423. In another example, the sub-system 414 is incorporated with a processor 104 such as an SoC. In yet another embodiment, the sub-system 414 is incorporated with the image sensor 108, which may also be incorporated with the processor 104.

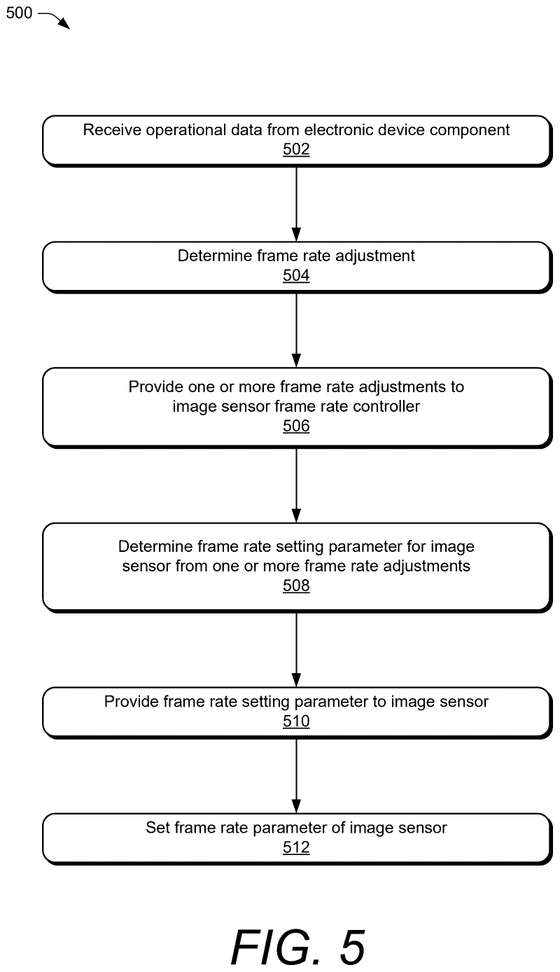

These and other capabilities and configurations, as well as ways in which entities of FIG. 4 act and interact, are described further with reference to methods 500-900. These entities may be further divided, combined, and so on. The environment 100 of FIG. 1 and 200 of FIG. 2, the example implementation 300 of FIG. 3 and 400 of FIG. 4, and the detailed illustrations of FIG. 5 through FIG. 9 illustrate some of many possible environments and devices capable of employing the described techniques.

Example methods 500 to 900 are described with reference to FIGS. 5-9 by way of example only and in accordance with one or more aspects of dynamic frame rate modulation for an image sensor. These methods are shown as sets of blocks that specify operations performed but are not necessarily limited to the order or combinations shown for performing the operations by the respective blocks. For example, any number of the described method blocks can be skipped or combined in any order to implement a method or an alternate method. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of example methods may be described in the general context of executable instructions stored on computer-readable media 204 that are local and/or remote to a computer processing system, and implementations can include software applications, programs, functions, and the like. Alternatively, or in addition, any of the functionalities described herein can be performed, at least in part, by one or more hardware logic components, such as, and without limitation, field-programmable gate arrays (FPGAs), application-specific integrated circuits (ASICs), application-specific standard products (ASSPs), SoC systems (SoCs), complex programmable logic devices (CPLDs), and the like.

FIG. 5 illustrates an example method 500 of dynamically adjusting a frame rate of an imaging device. At 502, an image sensor control module receives operational data 112 from one or more components of an electronic device 102, for example, one or more of image sensor control modules 405-1, 405-2, and 405-N. The image sensor control module may include a control module for temperature, power, or predicted temperature. Operational data may comprise temperature data, power consumption data, and the like as previously discussed with reference to FIG. 4.

At 504, a control module determines a frame rate adjustment, such as a frame rate adjustment 421, 422, and 423, based on operational data or predetermined values. Predetermined values can include threshold temperatures, thermal constraints, and/or user experience metrics for acceptable video capture quality. Operational data can include measured temperatures and measured power consumption or predicted values for future temperatures and power consumption for components of the electronic device 102, for example, and a current frame rate 415.

At 506, one or more image sensor control modules provide respective frame rate adjustments to an image sensor frame rate controller, such as, for example, frame rate adjustments (421, 422, and 423) to an image sensor frame rate controller 410. The frame rate controller 410 is configured to receive the frame rate adjustments and a current frame rate 415. At 508, the frame rate controller determines a frame rate setting 430 based on the one or more frame rate adjustments (421, 422, and 423), the current frame rate 415, and additional factors to provide the best frame rate setting parameter 430 based on predetermined metrics including a hysteresis model and smoothness of frame rate transitions, ensuring minimal user experience disruption, thermal policy limits, and proximity to thermal thresholds for SoC temperature and enclosure temperature.

Turning to 510, the image sensor frame rate controller provides a frame rate setting parameter to an image sensor. This can be effective to cause the image sensor to alter a frame rate of an image frame capture based on the frame rate setting parameter 430. The frame rate setting parameter may include a frame rate value or relative adjustment of the current frame rate of the image sensor. Finally, at 512, the image sensor frame rate controller applies the provided frame rate setting to the image sensor to set a current frame rate. In this manner, the method 500 implements a dynamic adjustment of a frame rate of an imaging device.

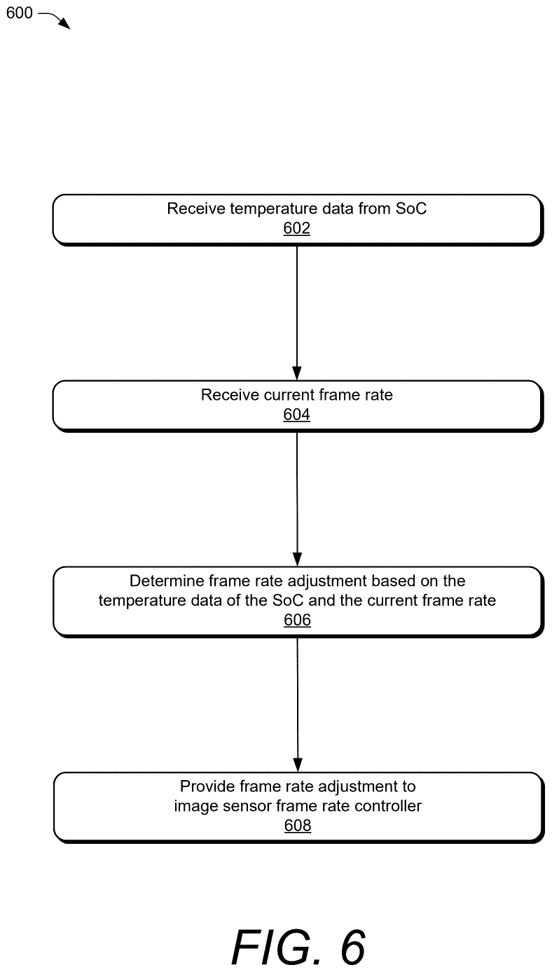

FIG. 6 illustrates an example method 600 of dynamically adjusting a frame rate of an imaging device. At 602, an image sensor control module (e.g., image sensor control module 405-1) receives operational data 112 from one or more components of an electronic device 102. Operational data 112 may comprise processor 104 temperature data, such as steady-state or peak SoC temperature values. At 604, the image sensor control module receives a current frame rate 415. At 606, the image sensor control module determines a frame rate adjustment, such as a frame rate adjustment 421, based on the operational data 112 and the current frame rate 415. In an example, this could include reducing a current frame rate by 10 or 15% or incrementally reducing a current frame rate by 30 or 60 fps over a predetermined time-period. Finally, at 608, the image sensor control module provides the frame rate adjustment to a frame rate controller, such as a frame rate controller 410.

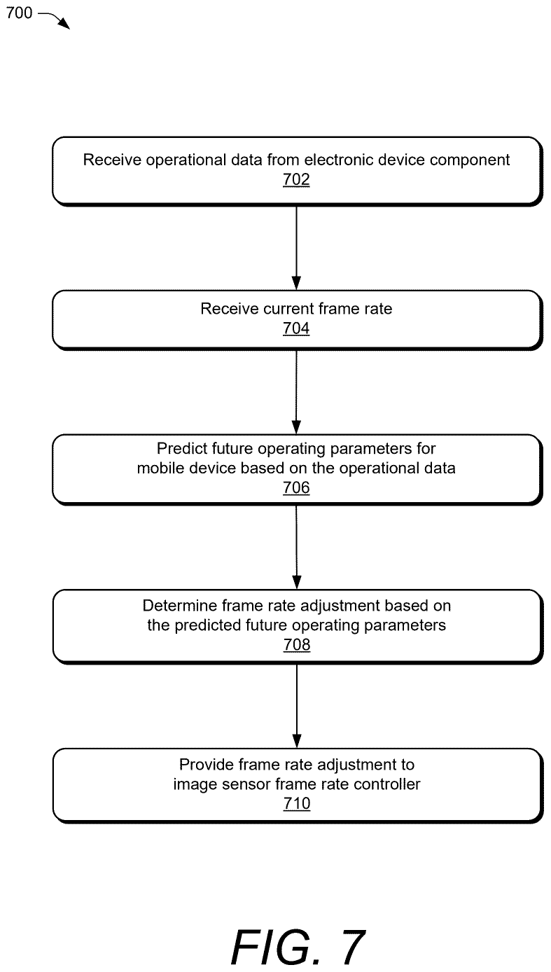

FIG. 7 illustrates an example method 700 of dynamically adjusting a frame rate of an imaging device. At 702, an image sensor control module (e.g., image sensor control module 405-2) receives operational data 112. Operational data 112 may comprise processor 104 temperature data, such as steady-state or peak SoC temperature values, an electronic device 102 enclosure temperature, power supply consumption values, and the like as discussed in relation to FIG. 4. At 704, the image sensor control module receives a current frame rate 415.

At 706, the image sensor control module predicts future electronic device operating parameters based on the received operational data 112 and the current frame rate 415. The predicted future operating parameters can be determined with logic through a prediction model to estimate future temperature and power consumption values for various components of the electronic device 102 using hysteresis models or linear and non-linear prediction models.

At 708 the image sensor control module determines a frame rate adjustment, such as a frame rate adjustment 422, based on the operational data 112, the current frame rate 415, and the predicted future operating parameters determined in 706. In an example, this could include reducing a current frame rate by 20 or 30% or incrementally reducing a current frame rate by 5 or 10 fps over a predetermined time-period until a fixed target frame rate is attained. Finally, at 710, the image sensor control module provides the frame rate adjustment to a frame rate controller, such as a frame rate controller 410.

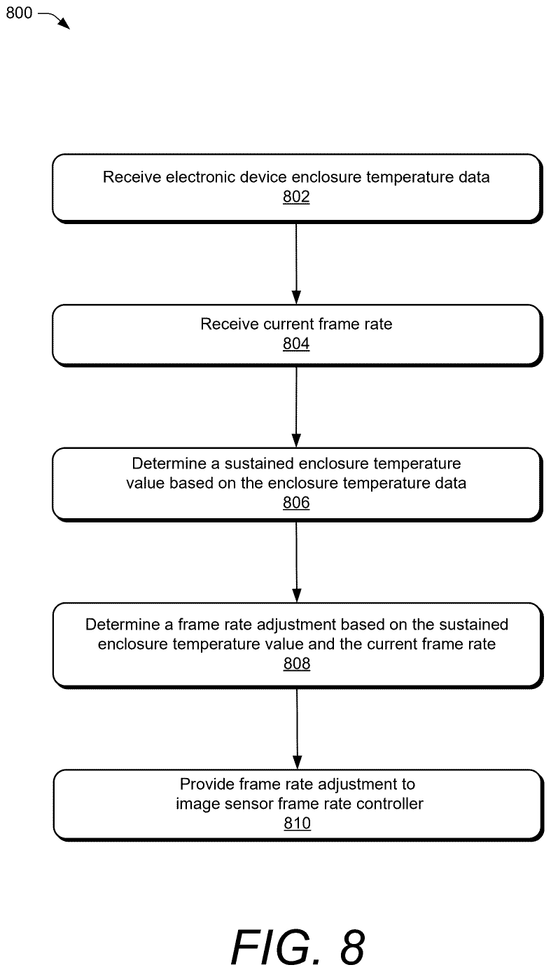

FIG. 8 illustrates an example method 800 of dynamically adjusting a frame rate of an imaging device. At 802, an image sensor control module (e.g., image sensor control module 405-N) receives operational data 112. Operational data 112 may comprise an electronic device 102 enclosure temperature. At 804, the image sensor control module receives a current frame rate 415. At 806, the image sensor control module determines a sustained enclosure temperature value based on the temperature data received in 802. The determination can be based on operational data 112, such as steady-state or peak device enclosure temperature values from one or more sensors, such as sensors 208. At 808, the image sensor control module determines a frame rate adjustment, such as a frame rate adjustment 423 based on the operational data 112 and the current frame rate 415. The frame rate adjustment determination can be based on predetermined factors such as threshold temperatures, thermal constraints, and user experience metrics for acceptable video capture quality as discussed with reference to FIG. 4. In an example, this could include reducing a frame rate by a factor that will guarantee that a device enclosure temperature remains below a predetermined threshold that keeps the electronic device comfortable to hold in a hand. Finally, at 810, the image sensor control module provides the frame rate adjustment to a frame rate controller, such as a frame rate controller 410.

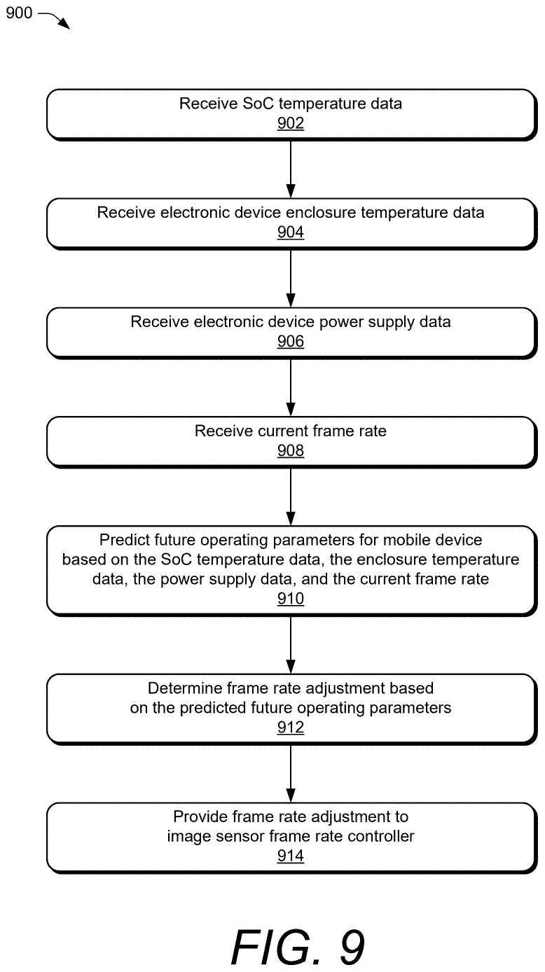

FIG. 9 illustrates another example method 900 of a method for dynamically adjusting a frame rate of an imaging device. At 902, an image sensor control module (e.g., image sensor control module 405-2) receives operational data 112 including a peak SoC temperature value. At 904, the image sensor control module receives operational data 112 including an electronic device 102 enclosure. At 906, the image sensor control module receives operational data 112 including electronic device 102 power supply data. At 908, the image sensor control module 405-2 receives a current frame rate 415.

At 910, the image sensor control module predicts future operating parameters based on the received SoC peak temperature data, electronic device 102 enclosure temperature data, electronic device 102 power supply data, and current frame rate 415. The predicted future operating parameters can be determined with logic through a prediction model to estimate future temperature and power consumption values for various components of the electronic device 102 while an image sensor of the electronic device 102 is operated at specific frame rates.

At 912, the image sensor control module determines a frame rate adjustment, such as a frame rate adjustment 422, based on the operational data 112, the current frame rate 415, and the predicted future operating parameters determined in 910. In an example, this could include increasing a frame rate over a time-period to enhance digital video capture or reducing a frame rate to maintain a safe operating temperature for an SoC to prevent an electronic device thermal shutdown. Finally, at 914, the image sensor control module provides the frame rate adjustment to a frame rate controller, such as a frame rate controller 410.

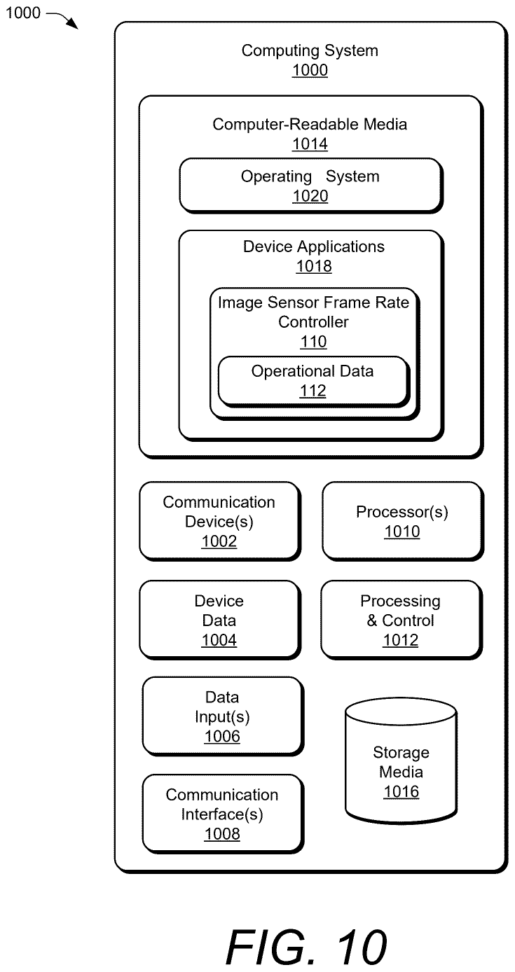

FIG. 10 illustrates various components of an example computing system 1000 that can be implemented as any type of client, server, and/or electronic device as described with reference to the previous FIGS. 1-9 to implement dynamic frame rate adjustment of an image sensor.

The computing system 1000 includes communication devices 1002 that enable wired and/or wireless communication of device data 1004 (e.g., radar data, authentication data, reference data, received data, data that is being received, data scheduled for broadcast, and data packets of the data). The device data 1004 or other device content can include configuration settings of the device, media content stored on the device, and/or information associated with a user of the device (e.g., an identity of a person within a radar field or customized air gesture data). Media content stored on the computing system 1000 can include any type of radar, biometric, audio, video, and/or image data. The computing system 1000 includes one or more data inputs 1006 via which any type of data, media content, and/or inputs can be received, such as human utterances, interactions with a radar field, touch inputs, user-selectable inputs or interactions (explicit or implicit), messages, music, television media content, recorded video content, and any other type of audio, video, and/or image data received from any content and/or data source.

The computing system 1000 also includes communication interfaces 1008, which can be implemented as any one or more of a serial and/or a parallel interface, a wireless interface, any type of network interface, a modem, and any other type of communication interface. The communication interfaces 1008 provide a connection and/or communication links between the computing system 1000 and a communication network by which other electronic, computing, and communication devices communicate data with the computing system 1000.

The computing system 1000 includes one or more processors 1010 (e.g., any of microprocessors, controllers, or other controllers) that can process various computer-executable instructions to control the operation of the computing system 1000 and to enable techniques for, or in which can be implemented, dynamic frame rate modulation of an image sensor. Alternatively or additionally, the computing system 1000 can be implemented with any one or combination of hardware, firmware, or fixed logic circuitry that is implemented in connection with processing and control circuits, which are generally identified at 1012. Although not shown, the computing system 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1000 also includes computer-readable media 1014, such as one or more memory devices that enable persistent and/or non-transitory data storage (e.g., in contrast to mere signal transmission), examples of which include RAM, non-volatile memory (e.g., any one or more of a ROM, flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. The computing system 1000 can also include a mass storage media device (storage media) 1016.

The computer-readable media 1014, which may be stored in data storage mechanisms, can include device data 1004 as well as various device applications 1018 and any other types of information and/or data related to operational aspects of the computing system 1000. In an aspect, computer-readable media 1014 stores various parameters in lookup tables for reference by device applications 1018. For example, an operating system 1020 can be maintained as a computer application with the computer-readable media 1014 and executed on the processors 1010. In accordance with one or more aspects described herein, the device applications 1018 may include an image sensor frame rate controller 110, in any form of a control application, a software application, signal-processing and control modules, code that is native to a particular device, an abstraction module, a machine-learned model, and so on. The image sensor frame rate controller 110 may also include operational data 112 such as power consumption data, device temperature data, and other device data. The device applications 1018 may also include system components, engines, modules, or managers to implement dynamic frame rate modulation of an image sensor. The computing system 1000 may also include, or have access to, one or more machine-learning systems.

### CONCLUSION

Although techniques using, and apparatuses including, dynamic frame rate adjustment of an image sensor have been described in language specific to features and/or methods, it is to be understood that the subject of the appended claims is not necessarily limited to the specific features or methods described. Rather, the specific features and methods are disclosed as example implementations of dynamic frame rate adjustment of an image sensor.

What is claimed is:

1. A method for managing a frame rate of an image sensor, the method comprising:
receiving, by a first image sensor control module, an indication of first operational data from a first component of a mobile computing device;
determining, by the first image sensor control module, a first frame rate adjustment for the image sensor based on the indication of the first operational data;
providing, by the first image sensor control module, the first frame rate adjustment for the image sensor to an image sensor frame rate controller;
determining, by the image sensor frame rate controller, a frame rate setting for the image sensor based on at least the first frame rate adjustment; and
setting a frame rate parameter of the image sensor based on the frame rate setting determined for the image sensor by the image sensor frame rate controller.

2. The method of claim 1, further comprising:
receiving, by a second image sensor control module, an indication of second operational data from a second component of the mobile computing device;
determining, by the second image sensor control module, a second frame rate adjustment for the image sensor based on the indication of the second operational data;
providing, by the second image sensor control module, the second frame rate adjustment for the image sensor to the image sensor frame rate controller;
determining, by the image sensor frame rate controller, the frame rate setting for the image sensor based on the first frame rate adjustment and the second frame rate adjustment; and
setting the frame rate parameter of the image sensor based on the frame rate setting determined for the image sensor by the image sensor frame rate controller based on the first frame rate adjustment and the second frame rate adjustment.

3. The method of claim 2, wherein:
the first image sensor control module comprises a system-on-chip (SoC) temperature monitor;
the first component of the mobile computing device comprises an SoC; and
the indication of the first operational data comprises one or more of a peak temperature value of the SoC of the mobile computing device and a current frame rate of the image sensor.

4. The method of claim 3, wherein:
the second image sensor control module comprises a temperature prediction module;
the second component of the mobile computing device comprises one of the SoC, a power supply monitor, and an enclosure temperature monitor; and
the indication of the second operational data comprises one of the peak temperature value of the SoC of the mobile computing device, power consumption data, an enclosure temperature value, and the current frame rate of the image sensor.

5. The method of claim 4, wherein:
the second image sensor control module comprises a sustained temperature monitor;
the second component of the mobile computing device comprises an enclosure temperature monitor; and
the indication of the second operational data comprises one of the enclosure temperature value and the current frame rate of the image sensor.

6. The method of claim 5 wherein the first operational data and the second operational data comprise real-time temperature data.

7. The method of claim 6, wherein the frame rate setting for the image sensor is determined based on a predefined image sensor frame rate setting associated with a perceptual human visual acuity model.

8. The method of claim 6, wherein the frame rate setting for the image sensor is determined based on a predefined minimum image sensor frame rate associated with one or more image quality factors.

9. The method of claim 8, wherein the frame rate setting for the image sensor is determined based on:
a predefined fixed value,
a hysteresis model of frame rate settings over SoC temperature, or
a transition of image sensor frame rates between a time-based interpolation of frame rates and a proportional frame rate adjustment model of frame rates.

10. The method of claim 2, wherein the frame rate setting for the image sensor is determined by the image sensor frame rate controller based on one of the first frame rate adjustment, the second image rate adjustment, or a threshold for an operational parameter of the mobile computing device.

11. The method of claim 10, wherein the operational parameter of the mobile computing device comprises a thermal stability model, the thermal stability model including a predefined thermal parameter, a predicted thermal parameter, or a measured thermal value.

12. The method of claim 11, wherein the predefined thermal parameter comprises one of a thermal coupling factor between an SoC and the image sensor, a maximum enclosure temperature value, or a predetermined mobile device thermal limit policy.

13. The method of claim 1, wherein the method is implemented by programmable software or programmable firmware of the mobile computing device.

14. A system-on-chip (SoC) for managing a frame rate of an image sensor, the SoC comprising:
an interface to an image sensor, the image sensor configured to operate based on a frame rate setting and provide an indication of a current frame rate of the image sensor;
an image sensor control module operably coupled to the interface to the image sensor, the image sensor control module configured to receive an indication of operational data from a component of a mobile computing device in which the SoC is embodied and determine a frame rate adjustment based on the indication of the operational data; and
an image sensor frame rate controller operably coupled to the image sensor control module and the image sensor, the image sensor frame rate controller configured to receive the frame rate adjustment and the current frame rate, determine a frame rate setting for the image sensor, and set a frame rate parameter of the image sensor based on the frame rate setting determined for the image sensor by the image sensor frame rate controller.

15. The system-on-chip of claim 14, wherein the image sensor control module is a first image sensor control module, the operational data is first operational data, the component is a first component of the mobile computing device, the frame rate adjustment is a first frame rate adjustment, and the SoC further comprises:
a second image sensor control module operably coupled to the interface to the image sensor, the second image sensor control module configured to receive an indication of second operational data from a second component of the mobile computing device and to determine a second frame rate adjustment based on the indication of the second operational data; and
the image sensor frame rate controller is further configured to receive the second frame rate adjustment and the current frame rate of the image sensor, determine a frame rate setting for the image sensor based on the first frame rate adjustment and the second frame rate adjustment, and set the frame rate parameter of the image sensor based on the frame rate setting determined for the image sensor by the image sensor frame rate controller based on the first frame rate adjustment and second frame rate adjustment.

16. The system-on-chip of claim 15, wherein the first image sensor control module comprises an SoC temperature monitor;
the first component of the mobile computing device comprises an SoC integrated with the image sensor; and
the indication of the first operational data comprises one or more of a peak temperature value of the SoC of the mobile computing device and the current frame rate of the image sensor.

17. The system-on-chip of claim 16, wherein the second image sensor control module comprises a temperature prediction module;
the second component of the mobile computing device comprises one or more of the SoC, a power supply monitor, and an enclosure temperature monitor; and
the indication of the second operational data comprises one of the peak temperature value of the SoC of the mobile computing device, dynamic power consumption data, an enclosure temperature value, real-time power supply temperature values, a power supply load value, and the current frame rate of the image sensor.

18. The system-on-chip of claim 16, wherein the second image sensor control module comprises a sustained temperature monitor;
the second component of the mobile computing device comprises an enclosure temperature monitor; and
the indication of the second operational data comprises one or more of an enclosure temperature value and the current frame rate of the image sensor.

19. A computer-readable media storing processor-executable instructions that, responsive to execution by a hardware-based processor, implement a frame rate control system for an image sensor of a mobile computing device to:
receive, by an image sensor control module, an indication of operational data from a component of a mobile computing device;
determine, by the image sensor control module, a frame rate adjustment for the image sensor based on the indication of the operational data;
provide, by the image sensor control module, the frame rate adjustment for the image sensor to an image sensor frame rate controller;
determine, by the image sensor frame rate controller, a frame rate setting for the image sensor based on the frame rate adjustment; and
set a frame rate parameter of the image sensor based on the frame rate setting determined for the image sensor by the image sensor frame rate controller.

20. The computer-readable media of claim 19, wherein the image sensor control module is a first image sensor control module, the operational data is first operational data, the component is a first component of the mobile computing device, the frame rate adjustment is a first frame rate adjustment, and the frame rate control system is further implemented to:
receive, by a second image sensor control module, an indication of second operational data from a second component of the mobile computing device;
determine, by the second image sensor control module, a second frame rate adjustment for the image sensor based on the indication of the second operational data;
provide, by the second image sensor control module, the second frame rate adjustment for the image sensor to the image sensor frame rate controller;
determine, by the image sensor frame rate controller, the frame rate setting for the image sensor based on the first frame rate adjustment and the second frame rate adjustment; and
set the frame rate parameter of the image sensor based on the frame rate setting determined for the image sensor by the image sensor frame rate controller based on the first frame rate adjustment and the second frame rate adjustm
